(19) United States
(12) Patent Application Publication
(10) Pub. No.: US 2025/0262664 A1
(43) Pub. Date: Aug. 21, 2025

(54) Additive Manufacturing Powder And Additively Manufactured Body

(71) Applicant: SEIKO EPSON CORPORATION, Tokyo (JP)

(72) Inventors: Yasutaka MATSUMOTO, Suwa (JP); Momoko WAKABAYASHI, Hachinohe (JP)

(21) Appl. No.: 19/053,844

(22) Filed: Feb. 14, 2025

(30) Foreign Application Priority Data
Feb. 16, 2024 (JP) 2024-022025

(51) Int. Cl. B22F 1/16; B33Y 70/10

(52) U.S. Cl. CPC B22F 1/16; B33Y 70/10; B22F 2304/10

(57) ABSTRACT

An additive manufacturing powder used for producing an additively manufactured body by a binder-jet method contains: a metal particle; and a coating film provided at a surface of the metal particle and containing a compound derived from a silane coupling agent. The silane coupling agent contains a structural unit represented by the following formula (1).

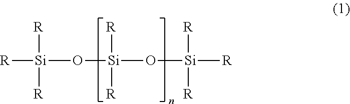

[In the formula (1), R's are functional groups independent of each other, and 50% or more of the functional groups R contain any organic group of a carboxy group, a hydroxy group, an amino group, and an epoxy group. Here, n is the number of repeating units and is 0 or more and 10 or less.]

The present application is based on, and claims priority from JP Application Serial Number 2024-022025, filed Feb. 16, 2024, the disclosure of which is hereby incorporated by reference herein in its entirety.

### BACKGROUND

### 1. Technical Field

The disclosure relates to an additive manufacturing powder and an additively manufactured body.

### 2. Related Art

As a technique for modeling a three-dimensional object, an additive manufacturing method using a metal powder is widely used in recent years. As one of such additive manufacturing methods, a binder-jet method is known.

JP-T-2006-515813 discloses a solid freeform fabrication system which ejects droplets different in volume as droplets of a binder to a powder layer using an inkjet printing technique, solidifies the powder to produce an object. A method of producing an object using such a system includes a step of ejecting droplets of a binder, and thus can be regarded as a type of the binder-jet method. According to such a system, it is possible to produce an object finished to have a smooth surface by ejecting droplets different in volume.

JP-A-2022-122503 discloses that a powder in which a cyclic-structure-containing group, a fluoroalkyl group, or a fluoroaryl group is introduced onto a particle surface of a metal powder is used as an additive manufacturing powder used in the binder-jet method. By introducing such a functional group, the additive manufacturing powder having high fluidity can be obtained, and thus a powder layer having a high filling ratio can be obtained. By increasing the filling ratio of the powder layer, an additively manufactured body having high shape accuracy is finally obtained.

In the binder-jet method, a water-based liquid (water-based binder solution) is often used as droplets of a binder. When the water-based binder solution permeates a powder layer, such a portion can be solidified.

However, in the additive manufacturing powder disclosed in JP-A-2022-122503, since the particle surface has high hydrophobicity, the water-based binder solution may not rapidly permeate the powder layer. In this case, since it takes time to permeate, a supply speed of the water-based binder solution may decrease, or a permeation range may become uneven. Thus, a production speed of an object (modeled body) decreases, and the shape accuracy of the produced object decreases.

Therefore, it is a problem to obtain a powder that improves fillability of a powder layer and improves permeability of a binder solution into the powder layer to enable efficient production of an additively manufactured body having high shape accuracy.

### SUMMARY

An additive manufacturing powder according to an application example of the disclosure is
an additive manufacturing powder used for producing an additively manufactured body by a binder-jet method, the additive manufacturing powder containing:
a metal particle; and
a coating film provided at a surface of the metal particle and containing a compound derived from a silane coupling agent, in which
the silane coupling agent contains a structural unit represented by the following formula (1).

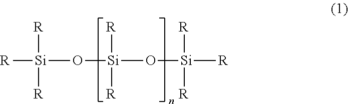

[In the formula (1), R's are functional groups independent of each other, and 50% or more of the functional groups R contain any organic group of a carboxy group, a hydroxy group, an amino group, and an epoxy group. Here, n is the number of repeating units and is 0 or more and 10 or less.]

An additively manufactured body according to an application example of the disclosure is
an additively manufactured body containing:
the additive manufacturing powder according to the application example of the disclosure; and
a binder that binds particles of the additive manufacturing powder.

### BRIEF DESCRIPTION OF THE DRAWINGS

FIG. 1 is a process diagram showing a configuration of a method for producing an additively manufactured body according to an embodiment.

FIG. 2 shows the method for producing an additively manufactured body shown in FIG. 1.

FIG. 3 shows the method for producing an additively manufactured body shown in FIG. 1.

FIG. 4 shows the method for producing an additively manufactured body shown in FIG. 1.

FIG. 5 shows the method for producing an additively manufactured body shown in FIG. 1.

FIG. 6 shows the method for producing an additively manufactured body shown in FIG. 1.

FIG. 7 shows the method for producing an additively manufactured body shown in FIG. 1.

FIG. 8 shows the method for producing an additively manufactured body shown in FIG. 1.

FIG. 9 shows the method for producing an additively manufactured body shown in FIG. 1.

FIG. 10 shows the method for producing an additively manufactured body shown in FIG. 1.

FIG. 11 is a cross-sectional view schematically showing an additive manufacturing powder according to the embodiment.

FIG. 12 shows an example of an infrared absorption spectrum obtained from the additive manufacturing powder.

FIG. 13 is a process diagram showing a method for producing a metal sintered body.

### DESCRIPTION OF EMBODIMENTS

Hereinafter, a preferred embodiment of an additive manufacturing powder and an additively manufactured body in the disclosure will be described in detail with reference to the accompanying drawings.

### 1. Method for Producing Additively Manufactured Body

First, a method for producing the additively manufactured body according to the embodiment will be described.

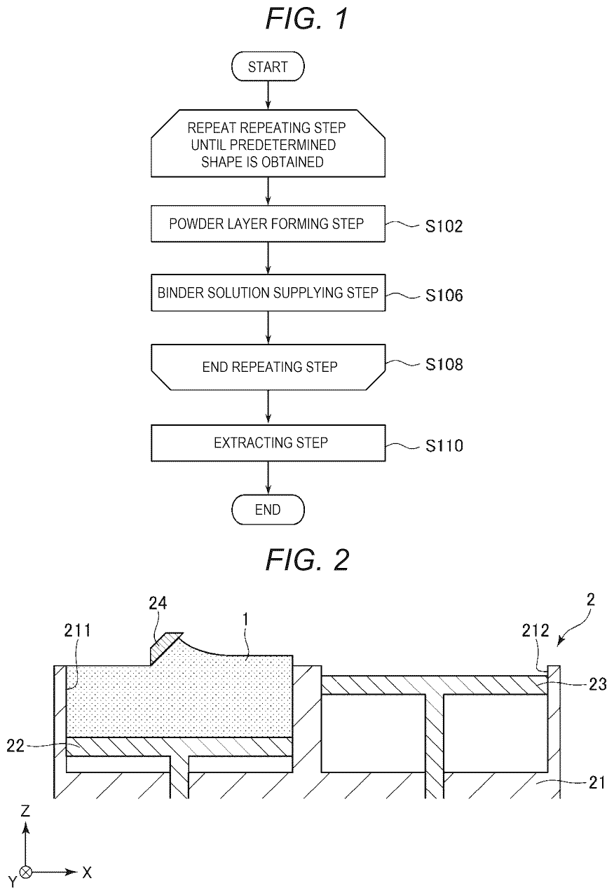

FIG. 1 is a process diagram showing a configuration of a method for producing the additively manufactured body according to the embodiment. FIGS. 2 to 10 show the method for producing the additively manufactured body shown in FIG. 1. In FIGS. 2 to 10, three axes orthogonal to each other are set as an X-axis, a Y-axis, and a Z-axis. Each axis is indicated by an arrow, and a tip side thereof is referred to as a “plus side” whereas a base side thereof is referred to as a “minus side”. In the following description, in particular, a plus side of the Z-axis is referred to as “upper”, and a minus side of the Z-axis is referred to as “lower”. In addition, both directions parallel to the X-axis are referred to as an X-axis direction, both directions parallel to the Y-axis are referred to as a Y-axis direction, and both directions parallel to the Z-axis are referred to as a Z-axis direction.

The method for producing the additively manufactured body shown in FIGS. 1 to 10 is a method called a binder-jet method, and includes a powder layer forming step S102, a binder solution supplying step S106, a repeating step S108, and an extracting S110 as shown in FIG. 1. The binder-jet method does not require a support structure for supporting a modeled object, and thus has an advantage that a modeled body having a complicated shape can be produced.

In the powder layer forming step S102, an additive manufacturing powder 1 is spread to form a powder layer 31. In the binder solution supplying step S106, a binder solution 4 is supplied to a predetermined region of the powder layer 31, and particles in the powder layer 31 are bound to each other to obtain a bound layer 41. In the repeating step S108, the powder layer forming step S102 and the binder solution supplying step S106 are repeated 1 or more times to stack the bound layers 41. Accordingly, an additively manufactured body 6 is obtained. In the extracting step S110, the additively manufactured body 6 is extracted from the powder layer 31. Hereinafter, each step will be sequentially described.

### 1.1. Additive Manufacturing Apparatus

First, prior to description of the powder layer forming step S102, an additive manufacturing apparatus 2 will be described.

As shown in FIGS. 2 to 10, the additive manufacturing apparatus 2 includes an apparatus main body 21 including a powder storage unit 211 and a modeling unit 212, a powder supply elevator 22 provided at the powder storage unit 211, a modeling stage 23 provided at the modeling unit 212, and a coater 24, a roller 25, and a liquid supply unit 26 which are movably provided on the apparatus main body 21.

As shown in FIG. 2, the powder storage unit 211 is a recess which is provided at the apparatus main body 21 and an upper portion of which opens. The additive manufacturing powder 1 is stored in the powder storage unit 211. An appropriate amount of the additive manufacturing powder 1 stored in the powder storage unit 211 is supplied to the modeling unit 212 by the coater 24.

The powder supply elevator 22 is disposed at a bottom portion of the powder storage unit 211. The powder supply elevator 22 is movable in an upper-lower direction in a state in which the additive manufacturing powder 1 is placed thereon. By moving the powder supply elevator 22 upward, the additive manufacturing powder 1 placed on the powder supply elevator 22 is pushed up to protrude from the powder storage unit 211. Accordingly, a protruding part of the additive manufacturing powder 1 can be moved toward the modeling unit 212.

The modeling unit 212 is a recess which is provided at the apparatus main body 21 and an upper portion of which opens. The modeling stage 23 is disposed inside the modeling unit 212. On the modeling stage 23, the additive manufacturing powder 1 is spread in layers by the coater 24. The modeling stage 23 is movable in the upper-lower direction in a state in which the additive manufacturing powder 1 is spread thereon. By appropriately setting a height of the modeling stage 23, an amount of the additive manufacturing powder 1 spread on the modeling stage 23 can be adjusted.

The coater 24 and the roller 25 extend in the Y-axis direction and are movable in the X-axis direction from the powder storage unit 211 to the modeling unit 212. The coater 24 can level and spread the additive manufacturing powder 1 in a layered manner by dragging the additive manufacturing powder 1. The roller 25 compresses the additive manufacturing powder 1 from above by rolling on the additive manufacturing powder 1 thus leveled.

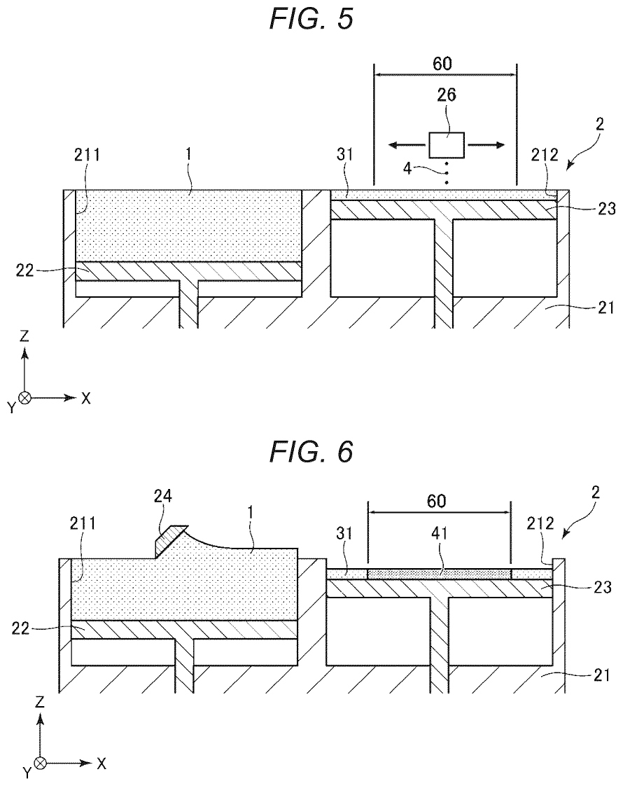

As shown in FIG. 5, the liquid supply unit 26 is implemented by, for example, an inkjet head and a dispenser, and is movable in the X-axis direction and the Y-axis direction at the modeling unit 212. The liquid supply unit 26 supplies an intended amount of the binder solution 4 to an intended position. The liquid supply unit 26 may include a plurality of ejection nozzles. The binder solution 4 may be ejected simultaneously or with a time difference from the plurality of ejection nozzles.

### 1.2. Powder Layer Forming Step

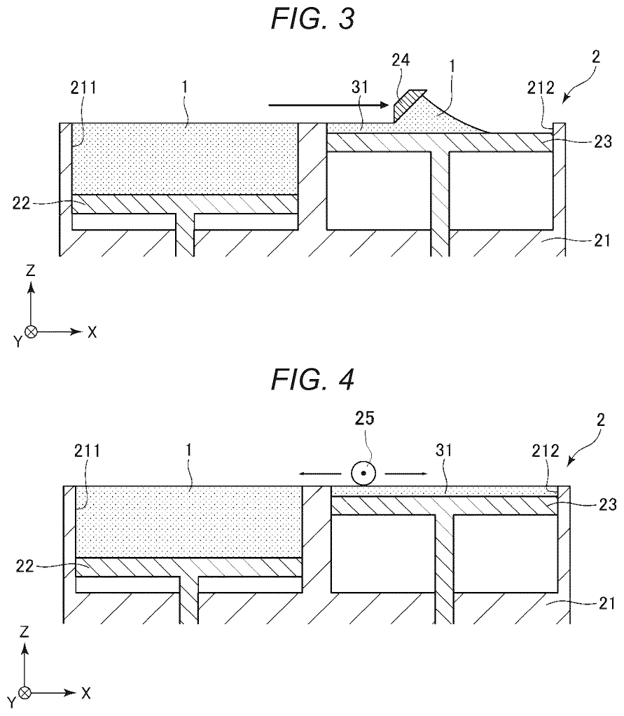

In the powder layer forming step S102, the additive manufacturing powder 1 is spread on the modeling stage 23 to form the powder layer 31. Specifically, as shown in FIGS. 2 and 3, using the coater 24, the additive manufacturing powder 1 stored in the powder storage unit 211 is dragged onto and leveled on the modeling stage 23 to have a uniform thickness. Accordingly, the powder layer 31 shown in FIG. 4 is obtained. At this time, a thickness of the powder layer 31 can be adjusted by lowering an upper surface of the modeling stage 23 below an upper end of the modeling unit 212 and adjusting a lowering amount.

The thickness of the powder layer 31 in this step is not particularly limited, and is preferably 2 times or more and 20 times or less, more preferably 3 times or more and 10 times or less, and still more preferably 4 times or more and 8 times or less an average particle diameter of a metal powder used in the additive manufacturing powder 1. If the thickness of the powder layer 31 is within the above range, shape accuracy of the finally obtained additively manufactured body 6 can be sufficiently improved.

When the thickness of the powder layer 31 is less than the lower limit value, the number of layers of the powder layer 31 necessary for producing the intended additively manufactured body 6 increases. Therefore, a time required for producing the additively manufactured body 6 may increase. On the other hand, when the thickness of the powder layer 31 exceeds the upper limit value, the bound layer 41 formed from the powder layer 31 is also thick, and thus the shape accuracy of the additively manufactured body 6 may decrease.

Next, as shown in FIG. 4, the roller 25 is moved in the X-axis direction while compressing the powder layer 31 in a thickness direction by the roller 25. Accordingly, a filling ratio of the additive manufacturing powder 1 in the powder layer 31 can be increased. The compression by the roller 25 may be performed as necessary, and may be omitted. The powder layer 31 may be compressed by a device different from the roller 25, such as a pressing plate.

A relative density of the powder layer 31 after compressing the powder layer 31 is preferably 40% or more, more preferably 45% or more and 70% or less, and still more preferably 50% or more and 65% or less. When the relative density is less than the lower limit value, a gap between particles in the powder layer 31 is large, and the binder solution 4 may not sufficiently permeate. On the other hand, when the relative density exceeds the upper limit value, the gap between the particles in the powder layer 31 may be excessively small. In this case, continuity of the gap may be impaired, and permeability of the binder solution 4 may decrease.

The relative density of the powder layer 31 is a ratio of a density of the powder layer 31 to a true density of a material constituting the additive manufacturing powder 1. The density of the powder layer 31 can be calculated based on a volume calculated from an area and the thickness of the powder layer 31, and mass of the powder layer 31.

### 1.3. Binder Solution Supplying Step

In the binder solution supplying step S106, as shown in FIG. 5, droplets of the binder solution 4 are ejected from the liquid supply unit 26 to a forming region 60 corresponding to the additively manufactured body 6 to be modeled in the powder layer 31. In the forming region 60 to which the binder solution 4 is supplied, particles of the additive manufacturing powder 1 are bound to each other, and the bound layer 41 shown in FIG. 6 is obtained.

The binder solution 4 is, for example, a liquid containing water and a binder component with which the particles of the additive manufacturing powder 1 can be bound to each other.

A surface tension of the binder solution 4 is preferably set to 20 mN/m or more and 40 mN/m or less, more preferably set to 20 mN/m or more and 35 mN/m or less, and still more preferably set to 20 mN/m or more and 30 mN/m or less. As the surface tension of the binder solution 4 increases, a driving force of permeation due to a capillary action tends to increase. Therefore, if the surface tension of the binder solution 4 is within the above range, the permeability of the binder solution 4 can be improved and shape accuracy of the bound layer 41 can be improved even when a particle surface of the additive manufacturing powder 1 has hydrophobicity.

When the surface tension of the binder solution 4 is less than the lower limit value, the driving force of permeation due to the capillary action may not sufficiently act on the binder solution 4 supplied to the powder layer 31. Therefore, the binder solution 4 may not sufficiently permeate the powder layer 31, and the shape accuracy of the bound layer 41 may decrease. On the other hand, when the surface tension of the binder solution 4 exceeds the upper limit value, the surface tension becomes excessive, and thus droplets of the binder solution 4 may be likely to be spherical. In this case, the binder solution 4 may not easily permeate the powder layer 31.

The surface tension of the binder solution 4 is measured using a surface tension meter. An example of the surface tension meter is a surface tension meter CBVP-Z manufactured by Kyowa Interface Science Co., Ltd.

Examples of the binder component contained in the binder solution 4 include fatty acids, paraffin waxes, micro waxes, polyethylene, polypropylene, polystyrene, acrylic resins, polyamide resins, polyesters, stearic acid, polyvinyl pyrrolidone (PVP), polyvinyl alcohol (PVA), polyethylene glycol (PEG), urethane resins, epoxy resins, vinyl resins, unsaturated polyester resins, and phenolic resins. The surface tension of the binder solution 4 tends to decrease by adding these components to a solvent or a dispersion medium containing water. Therefore, the surface tension of the binder solution 4 can be adjusted according to a type and an addition amount of the binder component.

Among these, polyvinyl alcohol (PVA) or polyvinyl pyrrolidone (PVP) is preferably used as the binder component. The binder solution 4 containing such a binder component has a suitable affinity and a suitable viscosity for the additive manufacturing powder 1, and also has a favorable binding property. Therefore, the binder solution 4 containing such a binder component contributes to production of the additively manufactured body 6 having particularly favorable shape accuracy.

A concentration of the binder component in the binder solution 4 is preferably 0.1 mass % or more and 20.0 mass % or less, more preferably 1.0 mass % or more and 15.0 mass % or less, and still more preferably 5.0 mass % or more and 12.0 mass % or less. Accordingly, the viscosity of the binder solution 4 is optimized, and a sufficient binding force between the particles of the additive manufacturing powder 1 can be ensured. By setting the concentration of the binder component within the above range, the surface tension of the binder solution 4 can be optimized.

When the binder solution 4 contains a liquid other than water, examples of the liquid include alcohols, ketones, and carboxylic acid esters, and a mixture containing at least one of the above may be used. By adding these components to water, the surface tension of the binder solution 4 tends to decrease. Accordingly, the surface tension of the binder solution 4 can be adjusted.

A content of water in the binder solution 4 is not particularly limited, and is preferably 60 mass % or more, more preferably 70 mass % or more, and still more preferably 80 mass % or more. Accordingly, a ratio of water in the binder solution 4 can be sufficiently high, and an environmental impact at the time of drying or disposal of the binder solution 4 can be reduced.

The binder solution 4 may contain an additive in addition to the above components. Examples of the additive include a viscosity modifier, a surfactant, a humectant, a stabilizer, an antifoaming agent, a crosslinking agent, and an antioxidant.

A total content of the additive in the binder solution 4 is preferably 20.0 mass % or less, and more preferably 1.0 mass % or more and 15.0 mass % or less.

A moving speed of the liquid supply unit 26 is not particularly limited, and is preferably 0.1 mm/s or higher and 20 mm/s or lower, more preferably 1 mm/s or higher and 15 mm/s or lower, and still more preferably 3 mm/s or higher and 10 mm/s or lower. By setting the moving speed of the liquid supply unit 26 within the above range, it is possible to improve accuracy of an ejection position of the droplets of the binder solution 4. As a result, the shape accuracy of the bound layer 41 can be improved, and the shape accuracy of the finally obtained additively manufactured body 6 can be improved.

When the moving speed of the liquid supply unit 26 is lower than the lower limit value, production efficiency of the additively manufactured body 6 may decrease. On the other hand, when the moving speed of the liquid supply unit 26 exceeds the upper limit value, the accuracy of the ejection position of the droplets decreases, and thus the shape accuracy of the bound layer 41 may decrease.

The moving speed of the liquid supply unit 26 is an average speed of the liquid supply unit 26 measured at a timing when the droplets of the binder solution 4 are ejected toward the forming region 60. The average speed is obtained by measuring a speed of the liquid supply unit 26 10 times or more at the timing when the droplets are ejected and calculating an average value thereof.

An ejection interval of the droplets of the binder solution 4 is not particularly limited, and is preferably 1 μm or longer and 90 μm or shorter, more preferably 5 μm or longer and 80 μm or shorter, still more preferably 10 μm or longer and 70 μm or shorter, and particularly preferably 20 μm or longer and 60 μm or shorter. By setting the ejection interval of the droplets of the binder solution 4 within the above range, the binder solution 4 can uniformly be supplied in a sufficient amount.

The ejection interval of the droplets of the binder solution 4 may be shorter than the lower limit value, but in this case, significant improvement in the shape accuracy of the additively manufactured body 6 cannot be expected, and meanwhile, it is difficult to increase the moving speed of the liquid supply unit 26, and thus the production efficiency of the additively manufactured body 6 may decrease. On the other hand, when the ejection interval of the droplets of the binder solution 4 exceeds the upper limit value, the droplets of the binder solution 4 landing on the powder layer 31 are excessively far from each other, and thus a continuous coating may not be formed. In this case, a probability of occurrence of particles that cannot bond increases, and thus the shape accuracy of the additively manufactured body 6 decreases.

The ejection interval of the droplets of the binder solution 4 is obtained by ejecting the binder solution 4 on a smooth surface that does not absorb the binder solution 4 under the same conditions as those during the ejection to the forming region 60, then measuring an interval between the ejected droplets within a range of 5 mm×5 mm, and calculating an average value of measured values thereof. The interval between the droplets is a distance between centers of droplets adjacent to each other. The average value is an average value of measured values obtained by measuring the interval for each of ten or more randomly extracted pairs of droplets.

A volume of each droplet of the binder solution 4 ejected from the liquid supply unit 26 is not particularly limited, and is preferably 1 pL or more and 10 pL or less, more preferably 1 pL or more and 8 pL or less, and still more preferably 2 pL or more and 6 pL or less. By setting the volume of the droplet of the binder solution 4 within the above range, in particular, the accuracy of the ejection position of the droplet at an outer edge of the bound layer 41 can be improved. Accordingly, it is possible to particularly improve shape accuracy of a portion corresponding to the outer edge of the bound layer 41 in the additively manufactured body 6.

When the volume of the droplet of the binder solution 4 is smaller than the lower limit value, it is difficult to increase the moving speed of the liquid supply unit 26, and thus the production efficiency of the additively manufactured body 6 may decrease. On the other hand, when the volume of the droplet of the binder solution 4 exceeds the upper limit value, mass of the droplet may increase. In this case, an impact when the droplet lands on the powder layer 31 increases, and the shape accuracy of the bound layer 41 decreases, which leads to a decrease in the shape accuracy of the additively manufactured body 6.

The volume of the droplet of the binder solution 4 is an average value of volumes obtained based on an observation result obtained by ejecting the binder solution 4 on a smooth surface that does not absorb the binder solution 4 under the same conditions as those during the ejection to the forming region 60 and then observing the droplet thus ejected in a plan view and a cross-sectional view. The average value is an average value of volumes obtained based on 10 or more droplets extracted randomly.

Simultaneously with or after the supply of the binder solution 4, the powder layer 31 to which the binder solution 4 is supplied may be subjected to a drying treatment. Examples of the drying treatment include a heat treatment and a gas blowing treatment. The drying treatment can promote drying of the powder layer 31 to which the binder solution 4 is supplied. Accordingly, the shape accuracy of the finally obtained additively manufactured body 6 can be further improved by controlling a permeation range of the binder solution 4 as intended.

A heating temperature in the heating is not particularly limited, and is preferably 50° C. or higher and 250° C. or lower, and more preferably 70° C. or higher and 200° C. or lower.

When the binder has photocurable or UV-curable properties, a light emission treatment or a UV emission treatment may be performed. Accordingly, the binder can be solidified or cured in a shorter time.

### 1.4. Repeating Step

In the repeating step S108, the powder layer forming step S102 and the binder solution supplying step S106 are repeated 1 or more times. That is, these steps are performed 2 or more times in total. Accordingly, a plurality of the bound layers 41 are stacked. By stacking the bound layers 41 in this manner, the additively manufactured body 6 having a desired three-dimensional shape shown in FIG. 10 is obtained.

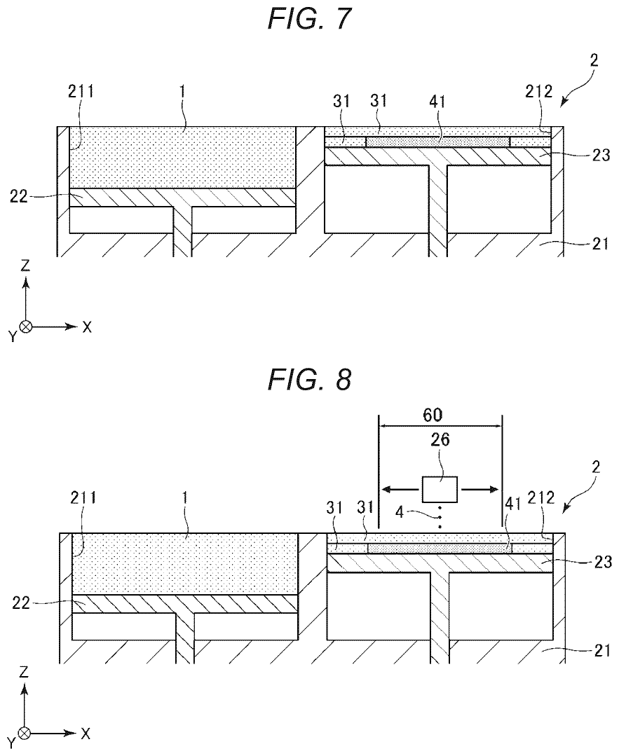

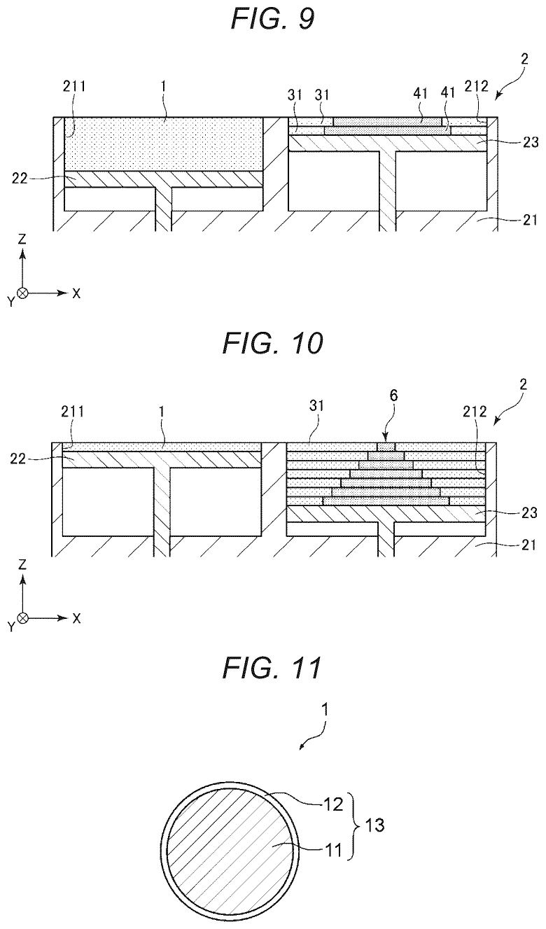

Specifically, first, a new powder layer 31 shown in FIG. 7 is formed on the bound layer 41 shown in FIG. 6. Next, as shown in FIG. 8, the binder solution 4 is supplied to the forming region 60 in the newly formed powder layer 31. Accordingly, the bound layer 41 as a second layer shown in FIG. 9 is obtained. The two bound layers 41 may have the same or different shapes.

### 1.5. Extracting Step

In the extracting step S110, the bound layer 41 is extracted from the powder layer 31. Accordingly, the additively manufactured body 6 is obtained.

In the powder layer 31, the additive manufacturing powder 1 that does not constitute the bound layers 41 is collected and reused as necessary, that is, used again for producing the additively manufactured body 6.

### 2. Additive Manufacturing Powder

Next, the additive manufacturing powder according to the embodiment will be described.

FIG. 11 is a cross-sectional view schematically showing the additive manufacturing powder 1 according to the embodiment.

The additive manufacturing powder 1 according to the embodiment is, for example, a powder used for producing the additively manufactured body 6 by the above-described binder-jet method.

The additive manufacturing powder 1 shown in FIG. 11 contains a plurality of surface-coated particles 13 each containing a metal particle 11 that contains a metal material and a coating film 12 covering a surface of the metal particle 11. The coating film 12 contains a compound derived from a silane coupling agent. The coating film 12 preferably covers the entire surface of the metal particle 11, or there may be a portion that is not covered.

### 2.1. Metal Particle

The metal material contained in the metal particle 11 is not particularly limited, and may be any material as long as the metal material has sinterability. Examples thereof include simple substances of Fe, Ni, Co, and Ti, and alloys and intermetallic compounds containing such simple substances as main components.

An Fe-based metal material is preferably used as the metal material. The Fe-based metal material refers to a metal material having an Fe content of more than 50% in terms of an atomic ratio. The Fe-based metal material is easily available and can be used to produce a metal sintered body having excellent mechanical properties.

Examples of the Fe-based metal material include stainless steel such as austenitic stainless steel, ferritic stainless steel, martensitic stainless steel, precipitation-hardening stainless steel, and austenitic-ferritic (duplex) stainless steel, low-carbon steel, carbon steel, heat-resistant steel, die steel, high-speed tool steel, an Fe—Ni alloy, and an Fe—Ni—Co alloy.

Among these, stainless steel is preferably used as the Fe-based metal material. Stainless steel is a type of steel excellent in mechanical strength and corrosion resistance. Therefore, by using the additive manufacturing powder 1 made of stainless steel, a metal sintered body having excellent mechanical strength and corrosion resistance and having high shape accuracy can be efficiently produced.

Examples of the austenitic stainless steel include SUS301, SUS301L, SUS301J1, SUS302B, SUS303, SUS304, SUS304Cu, SUS304L, SUS304N1, SUS304N2, SUS304LN, SUS304J1, SUS304J2, SUS305, SUS309S, SUS310S, SUS312L, SUS315J1, SUS315J2, SUS316, SUS316L, SUS316N, SUS316LN, SUS316Ti, SUS316J1, SUS316J1L, SUS317, SUS317L, SUS317LN, SUS317J1, SUS317J2, SUS836L, SUS890L, SUS321, SUS347, SUSXM7, and SUSXM15J1.

Examples of the ferritic stainless steel include SUS405, SUS410L, SUS429, SUS430, SUS430LX, SUS430J1L, SUS434, SUS436L, SUS436J1L, SUS445J1, SUS445J2, SUS444, SUS447J1, and SUSXM27.

Examples of the martensitic stainless steel include SUS403, SUS410, SUS410S, SUS420J1, SUS420J2, and SUS440A.

Examples of the precipitation-hardening stainless steel include SUS630 and SUS631.

Examples of the austenitic-ferritic (duplex) stainless steel include SUS329J1, SUS329J3L, and SUS329J4L.

The above-described symbols are material symbols based on the JIS standards. The types of stainless steel in the specification are distinguished by the above-described material symbols.

The additively manufactured body 6 may be produced using two or more types of additive manufacturing powders 1 containing different types of metal materials. For example, the additively manufactured body 6 may be divided into two portions, one portion may be produced using the additive manufacturing powder 1 made of a first metal material, and the other portion may be produced using the additive manufacturing powder 1 made of a second metal material.

### 2.2. Coating Film

The coating film 12 contains the compound derived from the silane coupling agent. By providing such a coating film 12, the additive manufacturing powder 1 that maintains high fluidity and high fillability at the time of forming the powder layer 31 can be obtained, and by providing the coating film 12, an affinity between the additive manufacturing powder 1 and the binder can be improved.

The silane coupling agent is a compound containing a structural unit represented by the following formula (1).

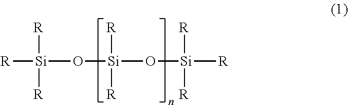

[In the formula (1), R's are functional groups independent of each other, and 50% or more of the functional groups R contain any organic group of a carboxy group, a hydroxy group, an amino group, and an epoxy group. Here, n is the number of repeating units and is 0 or more and 10 or less.]

The above organic groups are all organic groups that exhibit hydrophilicity. Therefore, when more than half of the functional groups R contained in the structural unit contain the organic group having hydrophilicity, the particle surface of the additive manufacturing powder 1 has appropriate hydrophilicity. Therefore, when the binder solution 4 is supplied in the binder solution supplying step S106, the permeability of the binder solution 4 with respect to the powder layer 31 can be improved. As a result, finally, the additively manufactured body 6 having high shape accuracy is obtained. The above compounds may be crosslinked to form a polymer. Accordingly, adhesion of the coating film 12 to the metal particle 11 can be further improved.

Each of the above organic groups may be an interacting group for a hydrogen bond. Therefore, the silane coupling agent is favorably bonded to the surface of the metal particle 11. Accordingly, the coating film 12 covering the surface of the metal particle 11 can be stabilized.

In the structural unit, a ratio of the number of the functional groups R containing the above organic group among all the functional groups R is preferably 50% or more and 100% or less, and more preferably 60% or more and 100% or less. Accordingly, a balance between hydrophilicity and hydrophobicity can be further optimized at the particle surface of the additive manufacturing powder 1. Accordingly, the additive manufacturing powder 1 that has excellent moisture resistance and can form the powder layer 31 enabling excellent permeability of the binder solution 4 is obtained.

When the ratio of the number of the functional groups R containing the above organic group is less than the lower limit value, the hydrophilicity of the particle surface of the additive manufacturing powder 1 decreases, and the permeability of the binder solution 4 may decrease. On the other hand, when the ratio of the number of the functional groups R containing the above organic group exceeds the upper limit value, the adhesion between the metal particle 11 and the coating film 12 may decrease in the particle of the additive manufacturing powder 1.

The functional group R refers to all atomic groups bonded to a Si atom. However, an oxygen atom interposed between Si atoms is excluded.

The functional group R may contain a monovalent group other than the above organic group. Such a monovalent group may be, for example, a hydrophobic organic group such as an alkyl group or an aryl group having 1 or more and 6 or fewer carbon atoms. When the functional group R contains the hydrophobic organic group, the additive manufacturing powder 1 having properties of both hydrophilicity and hydrophobicity is obtained. The additive manufacturing powder 1 has favorable fluidity and fillability even in a high-temperature and high-humidity environment and can form the powder layer 31 that enables excellent permeability of the binder solution 4.

When the functional group R includes the above organic group, the organic group may be located at a terminal of the functional group R, and any divalent group may be contained between the above organic group and the Si atom. Examples of the any divalent group include —NH—CO—, —NH—, —O—, —S—, —CO—, and —O—CO—.

It is preferable that at least one of the functional groups R contains a hydroxy group. The hydroxy group is likely to undergo dehydration condensation with a hydroxy group present at the surface of the metal particle. Accordingly, the adhesion of the coating film can be further improved.

In the structural unit, a ratio of the number of the functional groups R containing the hydroxy group is preferably 10% or more, more preferably 20% or more and 95% or less, and still more preferably 30% or more and 90% or less. Accordingly, the balance between hydrophilicity and hydrophobicity can be particularly optimized at the particle surface of the additive manufacturing powder 1.

It is preferable that at least one of the functional groups R contains a carboxy group. In particular, it is preferable that the functional groups R located at both terminals of a siloxane bond each contain a carboxy group. The carboxy group is likely to react between adjacent structural units and cause gelation. Accordingly, it is possible to obtain the silane coupling agent having excellent film-forming properties.

In the structural unit, a ratio of the number of the functional groups R containing the carboxy group is preferably 10% or more and 40% or less, and more preferably 15% or more and 35% or less. Accordingly, it is possible to obtain the coating film 12 having excellent film-forming properties and excellent adhesion to the surface of the metal particle 11.

In the functional groups R in the structural unit, a ratio of the number of alkoxy groups is preferably 10% or less, and more preferably 5% or less. Accordingly, an amount of alcohol generated when an alkoxy group is bonded to the particle surface of the additive manufacturing powder 1 can be reduced. As a result, it is possible to reduce an environmental impact and to prevent deterioration of quality of the coating film due to alcohol.

The number of repeating units n is 0 or more and 10 or less as described above, preferably 0 or more and 5 or less, and more preferably 0 or more and 2 or less. Accordingly, the coating film 12 can be evenly formed at the surface of the metal particle 11. As a result, the additive manufacturing powder 1 that has favorable fluidity and fillability and can form the powder layer 31 enabling excellent permeability of the binder solution 4 is obtained.

An average thickness of the coating film 12 is not particularly limited, and is preferably 100 nm or less, more preferably 0.5 nm or more and 50 nm or less, and still more preferably 1 nm or more and 10 nm or less. Accordingly, a film thickness necessary for maintaining the coating film 12 is ensured.

The average thickness of the coating film 12 can be specified by, for example, a qualitative and quantitative analysis in a depth direction using X-ray photoelectron spectroscopy and ion sputtering in combination. Specifically, a concentration of a component derived from the silane coupling agent is examined along the depth direction. A region where the concentration of the component derived from the silane coupling agent is relatively high is defined as the average thickness of the coating film 12. Specifically, when the concentration is changed in the vicinity of a boundary between the coating film 12 and the metal particle 11, a position corresponding to half of an amount of change in the concentration, that is, a midpoint between the concentration on the coating film 12 side and the concentration on the metal particle 11 side is regarded as the boundary, and a thickness from the boundary to a surface side may be treated as the average thickness of the coating film 12.

The coating film 12 may be a multilayer film in which molecules of the above-described compound are stacked in a plurality of layers, for example, two or more layers and ten or fewer layers, and is preferably a monomolecular film formed of the compound. A thickness of the coating film 12, which is a monomolecular film, can be minimized. As a result, when the additively manufactured body 6 is produced, the additively manufactured body 6 in which an occupancy rate of the coating film 12 is low whereas an occupancy rate of the metal particle 11 is high can be obtained. Such an additively manufactured body 6 is useful in obtaining a metal sintered body with high shape accuracy, for example, since a shrinkage rate is reduced when being subjected to a sintering treatment.

The monomolecular film can be formed using self-assembly of the silane coupling agent. Since the coupling agent is densely arranged on the surface of the metal particle 11, the monomolecular film can be efficiently formed.

As for whether the coating film 12 is a monomolecular film, for example, if the average thickness of the coating film 12 measured by the above-described method is equal to or less than a molecular size of the silane coupling agent, the coating film 12 can be evaluated as a monomolecular film.

The coating film 12 may contain any component other than the compound described above. In this case, from the viewpoint of reliably obtaining the above-described effects, a mass ratio of the compound described above is preferably more than 50%, more preferably 70% or more, and still more preferably 90% or more.

### 2.3. Various Characteristics of Additive Manufacturing Powder

Next, various characteristics of the additive manufacturing powder 1 will be described.

### 2.3.1. Infrared Spectroscopic Analysis

By subjecting the additive manufacturing powder 1 according to the embodiment to an infrared spectroscopic analysis, the permeability of the water-based binder solution 4 can be evaluated. Specifically, first, the additive manufacturing powder 1 is subjected to the infrared spectroscopic analysis to obtain an infrared absorption spectrum. A Fourier transform infrared spectrometer is used for the infrared spectroscopic analysis. In particular, an ATR method is preferably used. Next, areas of a waveform P1 derived from a Si—O bond (siloxane bond) and a waveform P2 derived from a C—H bond in the infrared absorption spectrum are acquired.

A top of the waveform P1 is located at a wavenumber of 1120 cm-1 or more and 1140 cm-1 or less. A top of the waveform P2 is located at a wavenumber of 2700 cm-1 or more and 3000 cm-1 or less.

In the additive manufacturing powder 1 according to the embodiment, the obtained infrared absorption spectrum has the waveform P1 and the waveform P2. A ratio P2/P1 of the area of the waveform P2 to the area of the waveform P1 is 0.5 or less, preferably 0.001 or more and 0.4 or less, and more preferably 0.01 or more and 0.2 or less.

When the ratio P2/P1 is within the above range, hydrophobicity derived from the C—H bond is limited at the particle surface of the additive manufacturing powder 1. Accordingly, the additive manufacturing powder 1 having appropriate hydrophilicity is obtained. As a result, the additive manufacturing powder 1 with which the powder layer 31 enabling excellent permeability of the binder solution 4 can be formed is obtained. A decrease in the moisture resistance of the additive manufacturing powder 1 can be limited, and thus fluidity and fillability can be ensured.

The ratio P2/P1 may be less than the lower limit value, but in this case, the moisture resistance of the additive manufacturing powder 1 may decrease, and the fluidity and the fillability may decrease. On the other hand, when the ratio P2/P1 exceeds the upper limit value, the permeability of the binder solution 4 in the powder layer 31 may decrease.

The waveform P1 and the waveform P2 may each overlap with a waveform derived from another bond. In such a case, waveform separation may be performed in a program for analyzing the infrared absorption spectrum, and areas of waveforms after the separation may be treated as the areas of the waveform P1 and the waveform P2.

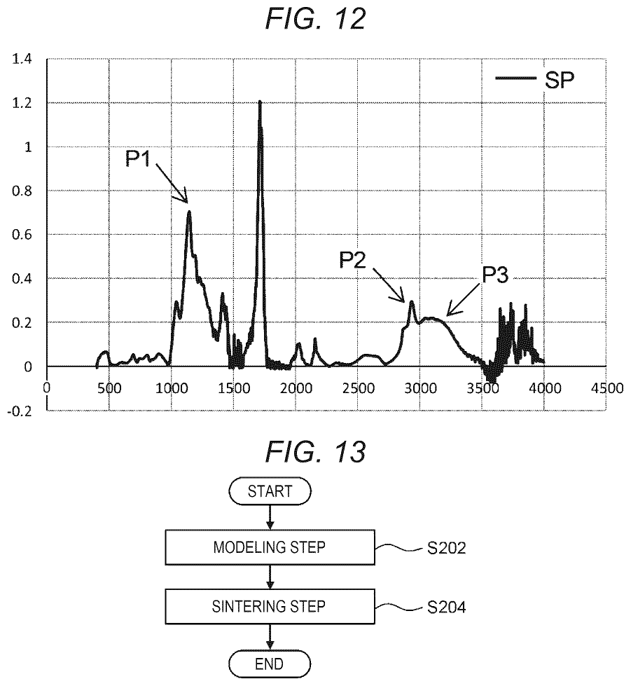

FIG. 12 shows an example of an infrared absorption spectrum SP obtained from the additive manufacturing powder 1. In FIG. 12, a horizontal axis represents a wavenumber (cm⁻¹), and a vertical axis represents absorbance.

The infrared absorption spectrum SP shown in FIG. 12 has the waveform P1 and the waveform P2. Meanwhile, the waveform P2 overlaps a waveform P3 derived from an 0-H bond. In such a case, the waveform P2 and the waveform P3 may be separated by a waveform separation program (curve fitting program).

### 2.3.2. Coverage Ratio

A ratio of an area covered by the coating film 12 to the entire surface of the metal particle 11 is referred to as a “coverage ratio”. In the additive manufacturing powder 1 according to the embodiment, the coverage ratio of the coating film 12 is preferably 10% or more and 150% or less, more preferably 20% or more and 120% or less, and still more preferably 30% or more and 100% or less. Accordingly, hydrophilicity can be uniformly imparted to the surface of the metal particle 11. Accordingly, the additive manufacturing powder 1 with which the powder layer 31 enabling particularly favorable permeability of the binder solution 4 can be formed is obtained.

The coverage ratio of the coating film 12 can be calculated based on an amount of the coating film 12, an amount of the metal particle 11, a minimum coverage area of the coupling agent, and a specific surface area of the metal particle 11. Among these, the amount of the coating film 12 can be calculated, for example, based on a concentration of an element of the silane coupling agent by performing a qualitative and quantitative analysis by X-ray photoelectron spectroscopy on the additive manufacturing powder 1. For example, when the coupling agent is the silane coupling agent, an amount of a compound constituting the coating film 12 can be calculated based on a Si concentration. The minimum coverage area of the coupling agent is available from a manufacturer or the like for each type of the coupling agent. The specific surface area of the metal particle 11 is measured using a specific surface area measuring apparatus after removing the coating film 12 from the additive manufacturing powder 1 using, for example, a chemical. As the specific surface area measuring apparatus, for example, a BET type specific surface area measuring apparatus HM1201-010 manufactured by MOUNTECH Co., Ltd. may be used.

### 2.3.3. Particle Size Distribution

Regarding the metal particle 11, when a volume-based particle size distribution is obtained by a laser diffraction type particle size distribution measuring apparatus, a particle diameter when a cumulative frequency is 50% from a small diameter side is defined as D50. An example of the apparatus for measuring the particle size distribution is Microtrac HRA 9320-X100 manufactured by Nikkiso Co., Ltd.

The particle diameter D50 (average particle diameter) of the metal particle 11 is preferably 1.0 μm or more and 15.0 μm or less, more preferably 3.0 μm or more and 12.0 μm or less, and still more preferably 4.0 μm or more and 10.0 μm or less. Accordingly, the additive manufacturing powder 1 that can produce the additively manufactured body 6 having excellent sinterability is obtained. In addition, the additive manufacturing powder 1 that has excellent fluidity and can form the powder layer 31 having a high filling degree is obtained.

When the particle diameter D50 is smaller than the lower limit value, particles of the additive manufacturing powder 1 may easily aggregate. When aggregation occurs, the fluidity of the additive manufacturing powder 1 may decrease, and a density of the metal sintered body may decrease. On the other hand, when the particle diameter D50 is larger than the upper limit value, sinterability of the additive manufacturing powder 1 decreases, and when the metal sintered body is obtained from the additively manufactured body 6, the density of the metal sintered body may decrease.

### 2.3.4. Water Contact Angle

The silane coupling agent used in the embodiment has a measured value within a predetermined range when a water contact angle is measured using the following method.

First, the silane coupling agent is diluted with pure water to prepare a 0.3 mass % solution. Next, the obtained solution is applied on a glass substrate to obtain a coating. Next, the glass substrate where the coating is formed is placed in a temperature-controlled chamber and dried by heating at 100° C. for 1 hour. Accordingly, a dry film is obtained on the glass substrate. Next, a water contact angle of the obtained dry film is measured using a contact angle measuring apparatus. As the contact angle measuring apparatus, a contact angle measuring apparatus, DropMaster 500 manufactured by Kyowa Interface Science Co., Ltd. is used. As a measurement method, a θ/2 method is used, and measurement is performed 5 seconds after landing. Measurement conditions are set to a temperature of 25° C., a relative humidity of 50%±5%, and a water drop amount of 3 μL.

When the water contact angle of the obtained dry film is measured using the above method, a measured value is preferably 30° or more and 90° or less, more preferably 400 or more and 80° or less, and still more preferably 50° or more and 70° or less. By using the silane coupling agent enabling the water contact angle to be within the above range, it is possible to obtain the additive manufacturing powder 1 that has favorable fluidity and fillability even in a high-temperature and high-humidity environment and can form the powder layer 31 enabling excellent permeability of the binder solution 4.

When the water contact angle is smaller than the lower limit value, the moisture resistance of the additive manufacturing powder 1 decreases, and the fluidity and the fillability may decrease. On the other hand, when the water contact angle exceeds the upper limit value, the hydrophilicity of the additive manufacturing powder 1 decreases, and the permeability of the binder solution 4 in the powder layer 31 may decrease.

The water contact angle is affected by the functional group R in the silane coupling agent. Therefore, when the functional group R contains a large amount of the above-described hydrophilic organic group, the water contact angle tends to decrease. On the other hand, when the functional group R contains a large amount of the above-described hydrophobic organic group, the water contact angle tends to increase. 2.3.5. Apparent Density and Tapped Density

An apparent density AD of the additive manufacturing powder 1 according to the embodiment is preferably 2.50 g/cm³ or more and 3.70 g/cm³ or less, more preferably 2.70 g/cm³ or more and 3.60 g/cm³ or less, and still more preferably 3.00 g/cm³ or more and 3.50 g/cm³ or less. When the apparent density AD is within the above range, favorable fillability can be ensured even in a natural state. Accordingly, when the powder layer 31 is formed using the additive manufacturing powder 1, the powder layer 31 having a high filling ratio can be formed. As a result, the dense additively manufactured body 6 having high shape accuracy can be obtained, and by using the additively manufactured body 6, the metal sintered body having a high density and high shape accuracy can finally be produced.

The apparent density AD of the additive manufacturing powder 1 is measured according to a metal powder bulk density measurement method specified in JIS Z 2504:2012. In addition, for the measurement of the apparent density AD, a powder characteristic evaluation apparatus, Powder Tester (registered trademark) PT-X manufactured by Hosokawa Micron Corporation is preferably used. Before the apparent density AD is measured, the additive manufacturing powder 1 to be measured is preferably left to stand in an environment at a temperature of 25° C. and a relative humidity of 50% for 1 hour or longer.

A tapped density TD of the additive manufacturing powder 1 is preferably 4.10 g/cm³ or more and 4.80 g/cm³ or less, more preferably 4.20 g/cm³ or more and 4.70 g/cm³ or less, and still more preferably 4.30 g/cm³ or more and 4.60 g/cm³ or less. When the tapped density TD is within the above range, a high filling ratio can be obtained when the powder layer 31 is leveled by the modeling stage 23 or compressed by the roller 25. Accordingly, the dense additively manufactured body 6 having high shape accuracy can be obtained, and by using the additively manufactured body 6, the metal sintered body having a high density and high shape accuracy can finally be produced.

The tapped density TD of the additive manufacturing powder 1 is measured by a powder characteristic evaluation apparatus, Powder Tester (registered trademark) PT-X manufactured by Hosokawa Micron Corporation. Before the tapped density TD is measured, the additive manufacturing powder 1 to be measured is preferably left to stand in an environment at a temperature of 25° C. and a relative humidity of 50% for 1 hour or longer.

A ratio of the tapped density TD to the apparent density AD of the additive manufacturing powder 1 is preferably 1.15 or more and 1.50 or less, more preferably 1.20 or more and 1.45 or less, and still more preferably 1.25 or more and 1.36 or less. When the ratio is within the above range, a difference in the filling ratio between the additive manufacturing powder 1 in a natural state and the additive manufacturing powder 1 after vibration, load, or the like is applied can be reduced. Therefore, a difference in the filling ratio is less likely to occur in the powder layer 31, and deformation or the like of the additively manufactured body 6 due to the difference in the filling ratio can be prevented.

Although the ratio may be less than the lower limit value, difficulty in producing the additive manufacturing powder 1 having such characteristics may increase. On the other hand, when the ratio exceeds the upper limit value, the difference in the filling ratio is large, which may cause deformation or the like of the additively manufactured body 6.

### 3. Method for Producing Additive Manufacturing Powder

Next, a method for manufacturing the additive manufacturing powder 1 will be described.

The additive manufacturing powder 1 is manufactured through, for example, a preparation step, a coupling agent reaction step, and a coating film forming step.

### 3.1. Preparation Step

In the preparation step, the metal particle 11 is prepared. The metal particle 11 may be produced by any method, and is preferably a particle produced by an atomization method such as a water atomization method, a gas atomization method, or a rotating water atomization method, and more preferably a particle produced by a water atomization method or a rotating water atomization method. A surface of the metal particle 11 produced by such a method is easily covered with a hydroxy group derived from water. Therefore, the adhesion of the coating film 12 can be improved, and the fluidity of the additive manufacturing powder 1 can be sufficiently high even when the coating film 12 is thin. As a result, it is possible to obtain the additively manufactured body 6 in which the occupancy rate of the metal particle 11 is higher than that of the coating film 12 and whose shrinkage rate at the time of sintering is small.

If necessary, a known pretreatment for generating a hydroxy group at the surface of the metal particle 11 may be performed.

### 3.2. Coupling Agent Reaction Step

In the coupling agent reaction step, the silane coupling agent is reacted with the metal particle 11. Examples of this operation include an operation of charging both the metal particle 11 and the silane coupling agent into a chamber and then heating the inside of the chamber (method 1), an operation of charging the metal particle 11 into a chamber and then spraying the silane coupling agent in the chamber while stirring the metal particle 11 (method 2), and an operation of charging water, the coupling agent, and an alkali solution such as ammonia or sodium hydroxide into a primary alcohol such as methanol, ethanol, or isopropyl alcohol, stirring, filtering, and then drying (method 3). The silane coupling agent is supplied by a method of static placement in the chamber or spraying into the chamber.

An amount of the silane coupling agent added is not particularly limited, and is preferably 0.01 mass % or more and 1.00 mass % or less, and more preferably 0.05 mass % or more and 0.50 mass % or less, with respect to the metal particle 11. Accordingly, the metal particle 11 can be evenly coated with the coating film 12. As a result, it is possible to obtain the additive manufacturing powder 1 that has favorable fluidity and fillability even in a high-temperature and high-humidity environment and can form the powder layer 31 enabling excellent permeability of the binder solution 4.

### 3.3. Coating Film Forming Step

In the coating film forming step, the metal particle 11 to which the silane coupling agent adheres is heated. Accordingly, the coating film 12 is formed at the surface of the metal particle 11, and the additive manufacturing powder 1 is obtained. The unreacted silane coupling agent can be removed by heating.

A heating temperature for the metal particle 11 to which the silane coupling agent adheres is not particularly limited, and is preferably 50° C. or higher and 300° C. or lower, more preferably 100° C. or higher and 250° C. or lower, and still more preferably 120° C. or higher and 200° C. or lower. A heating time is preferably 10 minutes or longer and 24 hours or shorter, more preferably 30 minutes or longer and 10 hours or shorter, and still more preferably 1 hour or longer and 6 hours or shorter. The heating time is a time during which the heating temperature continues. An atmosphere in the heat treatment is, for example, an ambient atmosphere or an inert gas atmosphere.

It is preferable that at least one of the coupling agent reaction step and the coating film forming step is performed in a sealed container, and it is more preferable that both steps are performed in a sealed container. Accordingly, it is possible to prevent denaturation and volatilization of the silane coupling agent. As a result, a reaction amount and an adhesion density of the silane coupling agent can be suitably controlled, and finally, the coating film 12 having intended characteristics can be formed.

### 4. Method for Producing Metal Sintered Body

By subjecting the additively manufactured body 6 to the sintering treatment, the metal sintered body is obtained.

FIG. 13 is a process diagram showing a method for producing the metal sintered body.

The method for producing the metal sintered body shown in FIG. 13 includes a modeling step S202 of obtaining the additively manufactured body 6 by the above-described method for producing the additively manufactured body, and a sintering step S204 of sintering the additively manufactured body 6 to obtain the metal sintered body.

### 4.1. Modeling Step

In the modeling step S202, the additively manufactured body 6 is obtained by the method for producing the additively manufactured body described above.

### 4.2. Sintering Step

In the sintering step S204, the additively manufactured body 6 is sintered to obtain the metal sintered body.

When the sintering treatment performed under the above-described conditions is referred to as “main sintering”, at least one of “pre-sintering” and “debinding” corresponding to a pretreatment of the main sintering may be performed on the additively manufactured body 6 as necessary. Accordingly, at least a part of the binder contained in the additively manufactured body 6 can be removed, or a part of the additively manufactured body 6 can be sintered. Accordingly, unintended deformation or the like in the main sintering can be prevented.

The metal sintered body obtained as described above can be used as a material constituting all or a part of a component for transportation equipment such as a component for an automobile, a component for a bicycle, a component for a railway vehicle, a component for a ship, a component for an aircraft, or a component for a spacecraft, a component for an electronic device such as a component for a personal computer, a component for a mobile phone terminal, a component for a tablet terminal, or a component for a wearable terminal, a component for electrical equipment such as a refrigerator, a washing machine, or a cooling and heating machine, a component for a machine such as a machine tool or a semi-conductor manufacturing apparatus, a component for a plant such as a nuclear power plant, a thermal power plant, a hydroelectric power plant, an oil refinery, or a chemical complex, a component for a timepiece, a metal utensil, and a decorative item such as jewelry or an eyeglass frame.

### 5. Effects of Embodiment

As described above, the additive manufacturing powder 1 according to the embodiment is an additive manufacturing powder used for manufacturing the additively manufactured body 6 using the binder-jet method, and contains the metal particle 11 and the coating film 12 that is provided at the surface of the metal particle 11 and contains the compound derived from the silane coupling agent. The silane coupling agent contains the structural unit represented by the following formula (1).

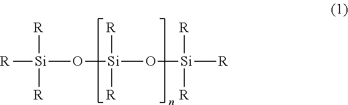

[In the formula (1), R's are functional groups independent of each other, and 50% or more of the functional groups R contain any organic group of a carboxy group, a hydroxy group, an amino group, and an epoxy group. Here, n is the number of repeating units and is 0 or more and 10 or less.]

According to such a configuration, it is possible to obtain the additive manufacturing powder 1 having favorable fillability, with which the powder layer 31 enabling high permeability of the binder solution 4 can be formed whereas the additively manufactured body 6 having high shape accuracy can be efficiently produced.

In the additive manufacturing powder 1 according to the embodiment, the number of repeating units n is 0 or more and 5 or less.

According to such a configuration, the coating film 12 can be evenly formed at the surface of the metal particle 11. As a result, the additive manufacturing powder 1 that has favorable fluidity and fillability and can form the powder layer 31 enabling excellent permeability of the binder solution 4 is obtained.

When the additive manufacturing powder 1 according to the embodiment is subjected to the infrared spectroscopic analysis, the obtained infrared absorption spectrum has the waveform P1 and the waveform P2. The waveform P1 is a waveform derived from the Si—O bond located at the wavenumber of 1120 cm⁻¹ or more and 1140 cm⁻¹ or less. The waveform P2 is a waveform derived from the C—H bond located at the wavenumber of 2700 cm⁻¹ or more and 3000 cm⁻¹ or less. The ratio P2/P1 of the area of the waveform P2 to the area of the waveform P1 is 0.5 or less.

According to such a configuration, the additive manufacturing powder 1 having appropriate hydrophilicity is obtained. As a result, the additive manufacturing powder 1 with which the powder layer 31 enabling excellent permeability of the binder solution 4 can be formed is obtained. A decrease in the moisture resistance of the additive manufacturing powder 1 can be limited, and thus fluidity and fillability can be ensured.

In the additive manufacturing powder 1 according to the embodiment, when the silane coupling agent is diluted to a concentration of 0.3 mass %, applied on a glass substrate, then a resulting coating is heated at 100° C. for 1 hour to dry, and a water contact angle of a resulting dry film is measured using a contact angle meter, a measured value is 30° or more and 90° or less.

According to such a configuration, it is possible to obtain the additive manufacturing powder 1 that has favorable fluidity and fillability even in a high-temperature and high-humidity environment and can form the powder layer 31 enabling excellent permeability of the binder solution 4.

In the additive manufacturing powder 1 according to the embodiment, the metal particle 11 has an average particle diameter of 1.0 μm or more and 15.0 μm or less.

According to such a configuration, the additive manufacturing powder 1 with which the additively manufactured body 6 having excellent sinterability can be produced is obtained accordingly. In addition, the additive manufacturing powder 1 that has excellent fluidity and can form the powder layer 31 having a high filling degree is obtained.

The additively manufactured body 6 according to the embodiment contains the additive manufacturing powder 1 according to the embodiment and the binder that binds particles of the additive manufacturing powder 1.

According to such a configuration, the additively manufactured body 6 having high shape accuracy is obtained.

Although the additive manufacturing powder and the additively manufactured body according to the disclosure are described above based on the shown embodiment, the disclosure is not limited thereto, and for example, a step for any purpose may be added to the above-described embodiment.

### EXAMPLES

Next, specific examples of the disclosure will be described.

### 6. Preparation of Additive Manufacturing Powder

First, metal particles were produced using a water atomization method. As a raw material, precipitation-hardening stainless steel SUS630 (17-4PH) was used. Next, a coating film was formed at obtained metal powder using a silane coupling agent. A reaction of the silane coupling agent and a subsequent heat treatment were performed in a state in which the metal powder and the silane coupling agent were charged in a sealed container. Accordingly, an additive manufacturing powder was obtained.

Next, an average particle diameter of the produced metal particles, a compound of the silane coupling agent, a ratio of functional groups containing a hydrophilic organic group in the silane coupling agent, a ratio of a hydroxy group, a ratio of a carboxy group, an area ratio P2/P1 in an infrared absorption spectrum, a coverage ratio of the coating film, a water contact angle, an apparent density, and a tapped density were measured. Measurement results are shown in Table 1.

Compounds shown in Table 1 are as follows.

Compound A-1: a compound containing a structural unit represented by the following formula (2) in which the functional group R contains a carboxy group and a hydroxy group

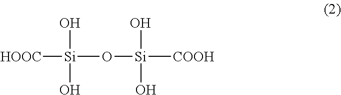

Compound A-2: a compound containing a structural unit represented by the following formula (3) in which the functional group R contains a primary amino group and a hydroxy group

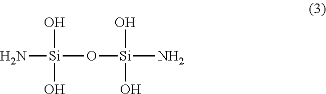

Compound A-3: a compound containing a structural unit represented by the following formula (4) in which the functional group R contains an alkylene glycol group and a hydroxy group

The alkylene glycol group is a group having a structure in which “—CH₂CH₂O—” is repeated 1 or more times. In the compound A-3, a terminal bonded to an oxygen atom is a methyl group.

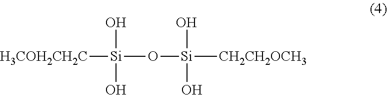

Compound B-1: 3-aminopropyltrimethoxysilane represented by the following formula (5)

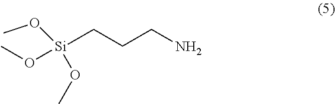

Compound C-1: phenyltrimethoxysilane represented by the following formula (6)

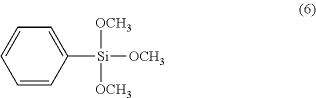 [SMILES: CO[Si](OC)(OC)c1ccccc1]

In Table 1, an additive manufacturing powder corresponding to the disclosure was referred to as an “Example”, and an additive manufacturing powder not corresponding to the disclosure was referred to as a “Comparative Example”.

### 6. Evaluation of Additive Manufacturing Powder

The additive manufacturing powder of each sample number was evaluated as follows.

### 6.1. Fillability

A heat treatment was applied to 50 g of the additive manufacturing powder of each sample number for 24 hours at 200° C. under an ambient atmosphere. Next, the additive manufacturing powder after the heat treatment was charged into a 50 mL screw-cap vial. Next, a height from a bottom surface to an upper surface of the powder was measured in a state in which the screw-cap vial was erected. Then the measured height was compared to the following evaluation criteria to relatively evaluate fillability of the additive manufacturing powder. Evaluation results are shown in Table 1.
A: the height is 25 mm or lower (the fillability is particularly high)
B: the height is higher than 25 mm and 30 mm or lower (the fillability is slightly high)
C: the height is higher than 30 mm (the fillability is low)

### 6.2. Water Permeability

The additive manufacturing powder of each sample number was charged in a container and pressed to have a relative density of 51%, thereby forming a powder layer having a size of 10 mm or more×10 mm or more and a thickness of 10 mm. The relative density of the powder layer was calculated based on a volume obtained from an area and the thickness of the powder layer and mass of the powder layer. Next, 40 μL of pure water was supplied to the powder layer as droplets. Then, an elapsed time from a time of supply until all supplied water permeates the powder layer was measured as a water permeation time. Water permeability was evaluated by comparing the obtained water permeation time with the following evaluation criteria.
A: the water permeation time is 0.10 seconds or longer and 2.00 seconds or shorter
B: the water permeation time is 0.05 seconds or longer and shorter than 0.10 seconds, or longer than 2.00 seconds and 5.00 seconds or shorter
C: the water permeation time is shorter than 0.05 seconds or longer than 5.00 seconds

### 7. Evaluation of Additively Manufactured Body (Evaluation of Shape Accuracy of Additively Manufactured Body)

First, using the additive manufacturing powder of each sample number, an additively manufactured body having a rectangular parallelepiped shape was manufactured by a binder-jet method. A size of the prepared additively manufactured body was 40 mm in length, 20 mm in width, and 5 mm in thickness. A PVP aqueous solution containing 10 mass % of PVP, 12 mass % of a humectant, and pure water as the remainder was used as a binder solution.

Next, the obtained additively manufactured body was observed with a digital microscope having a function as a non-contact type surface roughness measuring apparatus. Next, an arithmetic average roughness Ra of a surface of the additively manufactured body was measured based on an observation result. Then a measurement result was compared to the following evaluation criteria to relatively evaluate shape accuracy of the additively manufactured body. Evaluation results are shown in Table 1.
A: the arithmetic average roughness Ra is 4.0 μm or less (the shape accuracy is particularly high)
B: the arithmetic average roughness Ra is more than 4.0 μm and 7.0 μm or less (the shape accuracy is slightly high)
C: the arithmetic average roughness Ra is more than 7.0 μm and 10.0 μm or less (the shape accuracy is slightly low)
D: the arithmetic average roughness Ra is more than 10.0 μm (the shape accuracy is particularly low)

TABLE A

| | | Configuration of additive manufacturing powder | | | | | | |
|---|---|---|---|---|---|---|---|---|
| | | Average | Coupling agent | | | | | |
| | | particle | | Ratio of | | | | Coverage |
| | | diameter | | hydrophilic | Ratio of | Ratio of | | ratio of |
| | | of metal | | organic | hydroxy | carboxy | Ratio | coating |
| Sample | | particles | Compound | group | group | group | P2/P1 | film |
| No | Classification | μm | — | % | % | % | — | % |
| 1 | Example | 2.0 | A-1 | 100 | 87 | 3.3 | 0.10 | 70 |
| 2 | Example | 5.5 | A-1 | 100 | 87 | 3.3 | 0.12 | 95 |
| 3 | Example | 7.2 | A-1 | 100 | 87 | 3.3 | 0.05 | 90 |
| 4 | Example | 11.0 | A-1 | 100 | 87 | 3.3 | 0.01 | 85 |
| 5 | Example | 5.5 | A-2 | 100 | 87 | 0 | 0.20 | 70 |
| 6 | Example | 8.5 | A-3 | 87 | 87 | 0 | 0.25 | 45 |
| 7 | Comparative | 8.5 | B-1 | 25 | 0 | 0 | 0.70 | 80 |
| | example | | | | | | | |
| 8 | Comparative | 8.5 | C-1 | 0 | 0 | 0 | 0.90 | 90 |
| | example | | | | | | | |
| 9 | Comparative | 8.5 | — | — | — | — | — | — |
| | example | | | | | | | |

| | | | | | Evaluation result | | |
|---|---|---|---|---|---|---|---|
| | | | | | Additive | | |
| | | | | | manufacturing | | Shape |
| | Configuration of additive manufacturing powder | | | | powder | | accuracy of |
| | Water | Apparent | Tapped | | | Water | additively |
| | contact | density | density | TD/ | | perme- | manufactured |
| Sample | angle | AD | TD | AD | Fillability | ability | body |
| No | ° | g/cm³ | g/cm³ | — | — | — | — |
| 1 | 85 | 3.75 | 4.46 | 1.37 | B | B | B |
| 2 | 80 | 3.40 | 4.50 | 1.32 | A | A | A |
| 3 | 58 | 3.45 | 4.56 | 1.30 | A | B | B |
| 4 | 55 | 3.44 | 4.28 | 1.34 | B | A | B |
| 5 | 63 | 3.38 | 4.49 | 1.34 | A | A | B |
| 6 | 77 | 3.76 | 4.34 | 1.32 | B | B | B |
| 7 | 96 | 3.30 | 4.36 | 1.32 | B | B | C |
| 8 | 130 | 3.38 | 4.45 | 1.32 | A | C | D |
| 9 | 25 | 2.88 | 4.35 | 1.53 | C | A | D |

As shown in Table 1, it was observed that the additive manufacturing powder in each Example had favorable fillability and could form a powder layer having favorable water permeability. It was also observed that the additively manufactured body in each Example had high shape accuracy.

What is claimed is:

1. An additive manufacturing powder used for producing an additively manufactured body by a binder-jet method, the additive manufacturing powder comprising:
a metal particle; and
a coating film provided at a surface of the metal particle and containing a compound derived from a silane coupling agent, wherein
the silane coupling agent contains a structural unit represented by the following formula (1): 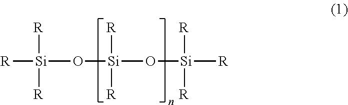
in the formula (1), R's are functional groups independent of each other, and 50% or more of the functional groups R contain any organic group of a carboxy group, a hydroxy group, an amino group, and an epoxy group, and n is the number of repeating units and is 0 or more and 10 or less.

2. The additive manufacturing powder according to claim 1, wherein the number of repeating units n is 0 or more and 5 or less.

3. The additive manufacturing powder according to claim 1, wherein
an infrared absorption spectrum obtained when the additive manufacturing powder is subjected to an infrared spectroscopic analysis has a waveform P1 derived from a Si—O bond located at a wavenumber of 1120 cm⁻¹ or more and 1140 cm⁻¹ or less, and a waveform P2 derived from a C—H bond located at a wavenumber of 2700 cm⁻¹ or more and 3000 cm⁻¹ or less, and
a ratio P2/P1 of an area of the waveform P2 to an area of the waveform P1 is 0.5 or less.

4. The additive manufacturing powder according to claim 1, wherein
when the silane coupling agent is diluted to a concentration of 0.3 mass % and applied on a glass substrate, then a resulting coating is heated at 100° C. for 1 hour to dry, and a water contact angle of a resulting dry film is measured using a contact angle meter, a measured value is 30° or more and 90° or less.

5. The additive manufacturing powder according to claim 1, wherein
the metal particle has an average particle diameter of 1.0 μm or more and 15.0 μm or less.

6. An additively manufactured body comprising:
the additive manufacturing powder according to claim 1; and
a binder that binds particles of the additive manufacturing powder.
